(19) United States
(12) Patent Application Publication
(10) Pub. No.: US 2014/0268030 A1
(43) Pub. Date: Sep. 18, 2014

(54) Pinhole Glasses

(71) Applicants: Stephen Castacane, Mildford, CT (US); John Kelman, Milford, CT (US)

(72) Inventors: Stephen Castacane, Mildford, CT (US); John Kelman, Milford, CT (US)

(21) Appl. No.: 13/802,788

(22) Filed: Mar. 14, 2013

(51) Int. Cl. G02C 7/02

(52) U.S. Cl. CPC G02C 7/021
USPC 351/159.52

(57) ABSTRACT

Pinhole glasses which can be used to assist people with low to moderate myopia, hyperopia, and astigmatism, are invented. The present invention can be used for glasses which function as progressive glasses, distance glasses, computer glasses, reading glasses, and when tinted, sunglasses. The present invention provides the best balance of visual acuity, brightness and visual field with emphasis on acuity, through the system of axes and the pinholes in multiple sizes along the axes which are clinically and empirically proven to be effective. Especially, the placement of pinholes along the axes has clinically and empirically been determined depending on the seriousness of the astigmatism of the users in correcting the astigmatic refractive errors. The size, number, spacing, pattern, and axes of the pinhole apertures have been optimized through optical theories and extensive clinical and empirical testing.

### BACKGROUND OF THE INVENTION

1. Field of the Invention

The present invention relates generally to pinhole glasses used to assist people with low to moderate myopia, hyperopia, and astigmatism by improving visual acuity and giving reasonable brightness of images in the majority of refractive errors. This invention more specifically, though not exclusively, relates to pinhole glasses that give the best combination of visual acuity, brightness, and visual field to maximize vision and provide the optimum visual experience with this form of optical correction, through extensive clinical testing.

2. Description of the Related Art

In recent past years, a vast variety of devices to aid the correction of the refractive errors of the eye for improving eyesight have been developed and introduced. Optical lenses, such as spectacles and contact lenses, are used for the correction of refractive errors of the eye. However, these lens devices only normalize the working of the eye by counterbalancing the refractive error with the refractive indices derived from the material and curvature of the lens. Thus, the refractive problems are not corrected or reduced by the repair of the structure of the eye, but rather by optical means. In addition to the devices for correction of the anatomical faults of the eye, the improvements related to sunglass lenses generally have concerned the optical properties of the lenses, including filtration and technologies to reduce the intensity of light, such as tinting and mirroring of lenses. Polarization of lenses filters light at specific axes to eliminate glare rays. Most sunglass lenses routinely reduce the amount of light reaching the retina, and can significantly reduce visual acuity and field, thereby interfering with the ability of a user to read, see and understand an instrument panel, discern a navigation screen, read a sign, view a map with associated text, or participate in any other activity requiring a greater amount of the available light. Thus, the concept of providing variable light transmission and filtration characteristics to an optical device by employing light polarizing elements which may be rotated with respect to each other has been developed and introduced.

As a method of assisting people with eye-conditioning and eye-improving, a plurality of apertures or pinholes has been employed in prior arts. For example, U.S. Pat. No. 6,592,221 disclosed a device which can be placed in front of the eye and fixed there temporarily, made from opaque material carrying body supplied with at least two (2) apertures or a plurality of apertures, placed on the axes of the two (2) eyes. U.S. Pat. No. 5,485,227 disclosed a light transmission adjustable spectacle structure with each lens comprising a fixed Polaroid lens and a rotatable Polaroid lens which has a number of aperture-like areas, where the lights are only allowed to pass through the apertures of the rotatable lens. In this invention, by rotating the rotatable lenses with respect to the fixed lenses, the light transmission through the lenses is gradually reduced if the polarization directions are changed from being parallel to being normal to each other. U.S. Pat. No. 5,305,027 disclosed a vision training device comprising a plurality of apertures on each lens to actuate foveal vision and to improve hand-eye coordination activities. U.S. Pat. No. 4,955,709 disclosed sun-shielding eyeglasses having lenses made of an opaque material provided with a plurality of closely-spaced, small holes to permit improved vision to the wearer, while excluding a high percentage of the external light and glare from reaching the eye of the wearer. U.S. Pat. No. 7,914,144 disclosed corrective eyewear that provides the option of using a lens or a pinhole aperture disposed adjacent to the lens. This invention adopted a plurality of pinhole apertures in accordance with a size gradient, with the smaller diameters at the bottom of the lens and the larger diameters at the top of the lens, U.S. Pat. No. 7,857,448 disclosed corrective eyewear that has a plurality of cone-shaped through holes provided in the lens of astigmatism-correcting eyeglasses. Each of cone-shaped through holes has a larger diameter at the inner side than at the outer side, and the cone-shaped through holes located nearer the circumference of the lens have larger inclined angles around the circumference of the lens than the cone-shaped through hole located at the center. The preferred embodiment of this invention is designed only to be used with curved lenses.

U.S. Pat. No. 3,876,294 disclosed a temporary or emergency substitute for any type of prescriptive eyeglasses, making it possible for most individuals having defective sight, without regard to the nature of the optical defect. In this invention, a single pinhole is placed at the axis of the circular zone surrounded by a center ridge and another eight (8) equi-spaced pinholes are placed within the annular zone entirely surrounded by a circular ridge. Then, another twelve (12) equi-spaced pinholes are placed within the annular zone partially surrounded by a peripheral ridge. All of the pinholes used in this invention are in the same size. U.S. Pat. No. 1,959,915 disclosed a lensless spectacle which increases the depth of sharp focus and permits the object being viewed to be moved forward or backward from the focal plane without blurring or imperfect focusing. This invention comprised opaque discs for replacing the lens in spectacles with discs having a series of openings which diminish in their size from the top to the bottom to produce sharp and clear vision at any range. The apertures are substantially in the same size of diameter and arranged in horizontal rows and spaced apart at a distance substantially equal to the pupil of the eye for the clearer vision.

As discussed above, a crude embodiment of pinhole eyeglasses has existed in which the same-sized pinholes or pinholes in accordance with a size gradient, evenly placed in an X-Y array, to assist people with vision problems. These prior devices have the effect of reducing the width of the bundle of diverging light rays coming from each point on the viewed object. By allowing only the parallel rays of light that do not need to be bent or refracted to reach the retina, pinhole glasses have provided an improved image at various distances, and eliminated the distortion at either side of the center line. However, by blocking the majority of the light, sufficient lighting on the viewed object was not easily provided. Thus, even though the user can see the object as its sharper image with the aid of pinhole glasses, the light on the object has frequently been compromised. Particularly when traditional pinhole glasses are used for reading, a good lamp must be provided nearby to compensate the diminished light for using the pinhole glasses. In addition, peripheral vision has been diminished from using the currently available pinhole glasses. Thus, individuals were recommended not to use the pinhole glasses for driving or similar activities involving motion.

In addition, none of the prior devices adopted any axes in placing apertures or pinholes. Even though some of the apertures or holes in prior devices are adopted to exclude external light and glare, those apertures or holes are not usually in different sizes. Even in cases that the plurality of pinhole apertures may be provided in accordance with a size gradient, the smaller diameters are provided at the bottom of the lens and the larger diameters are placed at the top of the lens. However, the clinical and empirical research has proven that the system of pinholes of larger diameters at the top and the smaller diameters at the bottom is not effective in optimizing acuity, brightness, and the diminished peripheral vision.

In light of the above, it would be advantageous to provide a solution to the inherent pinhole dilemma which results in the best balance of visual acuity (clarity), light transmission (brightness), and visual filed (peripheral vision). For this purpose, the present invention is a result of a combination of multiple known optical principles and over one year of clinical and empirical testing by a board-certified ophthalmologist. During the trial, twenty-six (26) different prototypes were tested and the preferred embodiment optimizes the visual experience through pinhole glasses by maximizing visual acuity, while minimizing the inherent reduction of brightness and field.

### SUMMARY OF INVENTION

The present invention includes improved pinhole glasses used to assist people with low to moderate myopia, hyperopia, and astigmatism by optimizing visual acuity for the majority of refractive errors, while minimizing the associated reduction of visual field and the reduction of light transmission to the eye. This invention provides a solution to the compromised brightness of currently available pinhole glasses by providing the best combination of acuity and brightness. This is accomplished through the utilization of specific aperture patterns involving specific axes, interaperture distance and aperture size, clinically and empirically proven to be most effective.

As a preferred embodiment, the present invention proposes pinhole glasses in which pinholes are placed along sixteen (16) equidistant axes including the 90 and 180 degree axes. The preferred embodiment may be used for people with myopia, hyperopia, and moderate astigmatism. As an alternative embodiment, the present invention proposes pinhole glasses in which with axes of pinholes are rotated 11.25 degrees to avoid the 90 and 180 degree axes, for the correction of refractive errors for people with high astigmatism. In this embodiment, the center pinhole size is increased to 1.5 mm as this central aperture size is consistently preferred by high astigmats.

All of the specifications of each embodiment in the present invention have clinically been optimized and determined to create the best balance of acuity and brightness, choosing variables that minimize diffraction and blur circle size and maximize light transmission, brightness and visual field. In addition, the number, size and pattern of peripheral pinholes allow for reasonable peripheral vision without compromising central acuity. These lenses can function as progressive glasses, distance glasses, computer glasses, reading glasses, and when tinted, sunglasses,

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 illustrates a perspective view of fully framed pinhole glasses of the present invention having pinhole lenses with a central pinhole, surrounded by circular and linear patterns of pinhole apertures, schematically representing the basic pinhole pattern;

FIG. 2 is a diagrammatic view of a pinhole lens used for people with hyperopia which involves an eye that is too short, or a cornea and/or intraocular lens that is too flat, so that images focus at a point posterior to the retina;

FIG. 3 is a diagrammatic view of a pinhole lens used for people with myopia which involves an eye that is too long or a cornea and/or intraocular lens that is too steeply curved, so that light rays focus anterior to the retina;

FIG. 4 is a diagrammatic view of a pinhole lens used for people with astigmatism, an optical defect in which vision is blurred due to the inability of the optics of the eye to focus a point object into a sharply focused point image on the retina, wherein the image focused has a linear representation on the retina;

FIG. 5 is a diagrammatic view of an exemplary embodiment of a pinhole lens of the present invention showing the central pinhole surrounded by two (2) concentric circles of pinholes of 125 mm in diameter, and sixteen (16) rows of pinholes radiating out linearly in equidistant axes including 90 and 180 degree axes; and

FIG. 6 is a diagrammatic view of an alternative embodiment of a pinhole lens of the present invention showing the specific axes and the diameters for the apertures along these axes. The central pinhole is 1.5 mm in diameter and there are no apertures in 90/180 degree axes, differing from the preferred embodiment.

### DETAILED DESCRIPTION OF THE PREFERRED EMBODIMENT

Referring initially to FIG. 1, the pinhole glasses of the present invention are shown and generally designated 10. The pinhole glasses 10 include pinhole lenses 100 formed with a plurality of pinholes 102 along determined axes. Pinhole glasses 100 include pinhole lenses 102, temple bars 101 which are positioned on the ears, and frames 103 which surround and support lenses 102. Lens 102 can be a light amber-colored lens which reduces glare, but increases contrast and depth perception with minimal reduction of brightness, which has been a major problem in the prior devices. Additionally, the pinhole pattern placed on the back surface of the lens will be substantially obscured by coating the anterior surface of the lens with a mirror coating.

The lens in this invention will be thin and can be flat or curved, and will initially be clear, made of plastic, such as CR 39 and tinted amber. In addition, by providing a process of laser etching of the negative pinhole pattern on the back surface of the lens for the precise pinhole apertures, diffraction from irregular pinhole edges may be minimized. Adopting this technique will result in improvement of the image quality over the previously available pinhole lenses.

Before the descriptions of FIGS. 2 through 6, the following abbreviations are provided in Table 1, in connection with accompanying names and drawings on FIGS. 2 through 4, in which like reference numerals designate like parts throughout.

TABLE 1
Abbreviations in connection with
accompanying names and drawings

| Numeral | Description | Abbreviation |
|---|---|---|
| 100 | Pinhole Lens | PHL |
| 102 | Pinhole Aperture | PHA |
| 104 | Retina | R |
| 106 | Cornea | C |
| 108 | Pupillary Axis | PA |
| 110 | Lens | L |
| 112 | Focal Point | FP |
| 114RB | Refracted Blocked Light Rays | RBLR |
| 114PT | Parallel Transmitted Light Rays | PTLR |
| 116 | Large Blurred Circle | LBC |
| 117 | Large Blurred Circle (Oblong) | LBC (Oblong) |
| 118 | Small Blurred Circle | SBC |

Referring to FIG. 2, a diagrammatic view of a pinhole lens (hereinafter, “PHL”) 100 used for people with hyperopia is depicted. With the aid of a pinhole aperture (hereinafter, “PHA”) 102, only the parallel transmitted light rays (hereinafter, “PTLR”) 114PT will reach the retina (hereinafter, “R”) 104 and a small blurred circle (hereinafter, “SBC”) 118 will be formed. The PHA will also function to block any refracted blocked light rays (hereinafter, “RBLR”) 114RB that need to be refracted or bent to reach the R 104. The PHL 100 works by allowing only the PTLR 114PT to be transmitted through the cornea (hereinafter, “C”) 106 through the intraocular lens (hereinafter, “L”) 110 to the R 104. The PHL 100 only allows the PTLR 114PT that do not need to be bent or refracted to reach the R 104. A distant point image is normally focused behind the R 104 in case of hyperopia, resulting in a large blurred circle (hereinafter, “LBC”) 116 on the R 104. The PHA 102, by eliminating the RBLR 114RB that require refraction, allow only the parallel rays of light to be transmitted to the R 104. This results in a SBC 118 forming on the R 104 which more accurately and clearly represents the initial point image. Because RBLR 114RB which require bending are blocked by the PHA 102 and only PTLR 114PT are allowed to pass, a SBC 118 on the R 104 will result as shown in FIG. 2.

FIG. 3 depicts a diagrammatic view of a PHL 100 used for people with myopia. With an aid of the PHA 102, the RBLR 114RB, which require bending by the C 106, through the PA 108 and by the L 110, are blocked. The blocked rays would be focused in front of the R 104, as shown by the FP 112. A distant point image is normally focused anterior to the R 104 in myopia, resulting in a LBC 116 on the R 104. Because the RBLR 114RB which require bending are blocked by the PHL 100, only the PTLR 114PT are transmitted, resulting in a much smaller blurred circle SBC 118 on the R 104. The result improves visual acuity of the users with myopia.

FIG. 4 depicts a diagrammatic view of a PHL 100 used for people with astigmatism. As described above, with an aid of the PHA 102, most light rays RBLR 114RB are blocked. In case of astigmatism, the abnormal corneal curvature results in multiple focal points on the R 104, instead of just a single point. This results in a linear representation on the R 104 of a distance point source of light and a resulting distorted, elongated vision. With multiple pinholes in various sizes and varying patterns along the axes, the present invention reduces a large linear blurred image in an oblong shape, (hereinafter, “LBC (Oblong)”) 117 into a SBC 118, rendering the image clearer and more proportionate.

As a preferred embodiment of the present invention, FIG. 5 depicts a diagrammatic view of a pinhole lens 200 with description of its axis, size, number, and spacing of the central, paracentral and peripheral apertures. At the preferred embodiment of this invention, the pinhole axis will be placed at 90 and 180 degrees, as well as every 22.5 degree in between, to correct astigmatic refractive errors, which occur most commonly at the 90 and 180 degree axes. The axes of the peripheral apertures would be placed at 0, 22.5, 45, 67.5, 90, 112.5, 135, 157.5, 180, 202.5, 225, 247.5, 270, 292.5, 315, 337.5 degrees, as shown in FIG. 5. The aperture in diameter of 1.25 mm is adopted in the preferred embodiment of the present invention. The pinhole size of 1.25 mm has clinically been determined to create the best combination of acuity and brightness, balancing the diffraction effect with the amount of light transmission. Through clinical testing for over one (1) year, the present invention has reached the optimum balance of visual acuity, light transmission, and visual field with emphasis on acuity. Especially, by providing alternatively optimized solutions for people either with low astigmatism or with more serious astigmatism, the present invention provides advantages over the above mentioned prior arts.

The central pinhole 202, the paracentral circular pattern of eight (8) pinholes 206, and the multiple pinholes in the horizontal axis at 0 and 180 degrees on each lens will allow for a wider choice of central viewing and accommodate virtually all interpupillary distances. This is extremely important as it allows for three-dimensional vision. This aspect is routinely missing in other products with only one (1) eye being able to align with a central or paracentral pinhole. Consequently, in other designs, fusion cannot occur and once three-dimensional vision is not achieved, higher levels of depth perception are accordingly lost. The preferred and alternative embodiments of the present invention maximize the user's ability to view objects with both eyes and enable to achieve the highest levels of depth perception. In a preferred embodiment, the spacings between peripheral apertures 204 are 3.75 mm as shown in FIG. 5. The initial spacing between the central pinhole 202 and the paracentral pinhole 204 is 4.125 mm. The diameter 201 of the pinhole lens 200 is 40 mm, as depicted in FIG. 5. All of these size, number, and spacing of the pinholes and pinhole lens are optimized for the visual acuity through clinical testing for over one (1) year.

As an alternative embodiment of the present invention for high astigmatism correction, FIG. 6 depicts a diagrammatic view of a pinhole lens 300 with description of its axis, size, number, and spacing of the central, paracentral and peripheral apertures. In this embodiment of the present invention, the pinhole axes will be placed at 11.25, 33.75, 56.25, 78.75, 101.25, 123.75, 146.25, 168.75, 191.25, 213.75, 236.25, 258.75, 281.25, 303.75, 326.25, and 348.75 degrees. Particularly, the axes in the alternative embodiment are designed to avoid the 90 and 180 degree axis, the most common astigmatic axes, so that light will not be transmitted to the retina at these axes for the greatest amount of astigmatic correction. To correct astigmatic refractive errors, the preferred embodiment in the present invention adopted to place pinholes at 90 and 180 degree axes, since for people with low astigmatism, their visionary acuity can be enhanced through the pinholes at the axes that astigmatic refractive errors most commonly occur. However, for people with much higher astigmatism, the clinical and empirical testing determined that the effect of astigmatic correction through pinholes placed at 90 and 180 degree axes was minimal. Rather, the clinical and empirical testing proved that the corrective effect for the refractive errors could be maximized when 90 and 180 degree axes are specifically avoided in placing the pinholes.

The apertures comprising the larger aperture 302 in the center of the lens and smaller apertures 304 toward the edge of the lens are adopted in the alternative embodiment of the present invention. The larger aperture 302 at the center is 1.5 mm in its diameter and the smaller apertures 304 which are in paracentral and peripheral circular pattern are 1.25 mm in their diameters. The pinhole sizes of 1.5 mm and 1.25 mm have been determined clinically to create the best visual acuity by balancing the effects of acuity, diffraction and reduced light transmission, when used in accordance with the combination of these axes in the alternative embodiment of the present invention. As discussed in the preferred embodiment, the central pinhole 302, the paracentral circular pattern of sixteen (16) pinholes 306, and the linear pinholes will accommodate a large group of people with astigmatism. The diameter 301 of the pinhole lens 300 is 38.10 mm, as depicted in FIG. 6. All of the size and number, orientation and pattern of pinholes and pinhole lens are optimized for the best balance of visual acuity, brightness and visual field, through over one (1) year of clinical and empirical investigations.

What is claimed is:

1. Pinhole glasses to assist people with low to moderate myopia, hyperopia, and astigmatism, comprising:
pinhole lenses;
temple bars; and
frame

2. Pinhole lenses of claim 1 comprising the system of:
specific axes;
aperture patterns involving specific axes;
aperture size; and
interaperture distance;

3. The preferred embodiment in the present invention is used for people with myopia, hyperopia, and moderate astigmatism, comprising:
pinhole lenses comprising pinholes placed along sixteen (16) equidistant axes;
including the 90° and 180° axes; and
pinholes in size of 1.25 mm in their diameters;

4. Diameter of the pinhole lens of claim 3 is 40 mm;

5. The interaperture distances for pinholes of claim 3 are:
3.75 mm between the peripheral apertures; and
4.125 mm between a central aperture and the paracentral apertures;

6. The alternative embodiment in the present invention is used for people with high astigmatism, comprising:
pinhole lenses comprising pinholes placed along sixteen (16) equidistant axes, rotated by 11.25° from 0° axis, particularly excluding the 90° and 180° axes;
pinholes in paracentral and peripheral circular pattern in size of 1.25 mm in their diameters; and
a pinhole at the center in size of 1.5 mm in its diameter;

7. Diameter of the pinhole lens of claim 6 is 38.10 mm; and

8. All of the size, number, orientation and pattern of pinholes and pinhole lens of claims 1, 3, 4, 5, 6 and 7 are optimized for the best balance of visual acuity and brightness and visual field, through over one (1) year of clinical and empirical investigations by a board-certified ophthalmologist.
